(19) United States
(12) Patent Application Publication
(10) Pub. No.: US 2003/0099800 A1
(43) Pub. Date: May 29, 2003

(54) Multilayer hose for conveying motor vehicle fluids

(75) Inventors: Guillaume Miguel, Concues En Ouche (FR); Pierre Milhas, Vitry Le Francois (FR)

Correspondence Address: YOUNG & THOMPSON, 745 SOUTH 23RD STREET 2ND FLOOR, ARLINGTON, VA, 22202

(73) Assignee: NOBEL PLASTIQUES, Marolles (FR)

(21) Appl. No.: 10/299,826

(22) Filed: Nov. 20, 2002

(30) Foreign Application Priority Data
Nov. 27, 2001 (FR) 0115297

(51) Int. Cl. B32B 1/08

(52) U.S. Cl. 428/36.91

(57) ABSTRACT

A multilayer hose for conveying a motor vehicle fluid, the hose comprising:

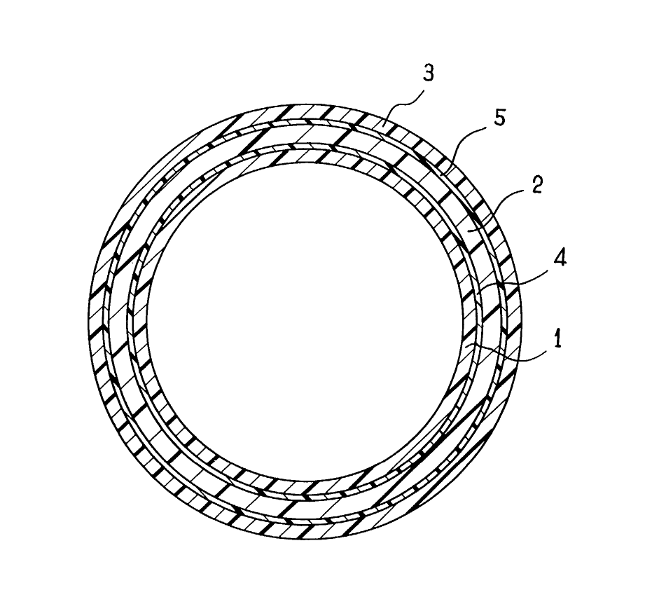

an inner layer of polyamide;

an intermediate layer based on a mixture of polyamide and polyolefin; and

an outer layer of a thermoplastic elastomer material based on polyester-ether.

The present invention relates to a hose for conveying motor vehicle fluids, and more particularly for conveying fuel.

### BACKGROUND OF THE INVENTION

Numerous single-layer or multilayer structures exist based on thermoplastic materials.

Single-layer structures of polyamide 11 or polyamide 12 are thus known, the use of said structures being relatively widespread despite their high cost.

At present, environmental concerns have become a central preoccupation and they are the subject of legal dispositions (such as the EURO 2000 European Directive) to which motor vehicle manufacturers are obliged to conform. Furthermore, technological progress has lead to a stiffening of the operating conditions, in particular the temperature conditions, to which hoses of this type are subjected, and more particularly when said hoses are installed in the engine compartment of the vehicle.

Unfortunately, known structures based on thermoplastic material are generally not suited to the new constraints.

### SUMMARY OF THE INVENTION

The invention provides a multilayer hose for conveying motor vehicle fluids, the hose comprising:

an inner layer of polyamide;

an intermediate layer based on a mixture of polyamide and polyolefin; and

an outer layer of a thermoplastic elastomer material based on polyester-ether.

This structure presents low permeability to motor vehicle fluids such as fuel, and it also presents good resistance to fluids with which it may come into contact when used in a motor vehicle, in particular oil, zinc chloride, screen wash, fuel . . . The hose of the invention is further adapted to operating at temperatures lying in the range 125° C. to 150° C. In addition, the hose is not costly.

### BRIEF DESCRIPTION OF THE DRAWING

Other characteristics and advantages of the invention appear on reading the following description of a particular non-limiting embodiment of the invention.

Reference is made to the sole accompanying FIGURE which is a cross-section of a hose of the invention.

### MORE DETAILED DESCRIPTION

With reference to the FIGURE and in accordance with the invention, the hose has a multilayer structure which comprises five layers, namely, from the inside to the outside: an inner layer 1, a first bonding layer 4, an intermediate layer 2, a second bonding layer 5, and an outer layer 3.

The inner layer 1 is made of polyamide, preferably a polyamide 6.

The intermediate layer 2 is based on a polyamide and a polyolefin. Specifically, the polyamide is a polyamide 6 and the polyolefin is polyethylene. The material used is the material referenced ORGALLOY produced by the supplier ATOFINA, for example;

The outer layer is made of an elastomer thermoplastic material based on polyester-ether. The material used is the material produced under the reference ARNITEL by the supplier DSM, for example.

The first bonding layer 4 is made of a material presenting adhesive properties relative to the material of the inner layer 1 and the material of the intermediate layer 3.

The second bonding layer 5 is made of a material presenting adhesive properties relative to the intermediate layer 2 and the outer layer 3.

It should be observed that the bonding layers 4 and 5 are optional when the intermediate layer presents sufficient adhesive properties relative to the material of the inner layer 1 and the material of the outer layer 3 to ensure the cohesion of the various layers with one other.

By way of example, the inner layer 1 is of thickness lying in the range about 0.2 millimeters (mm) to 0.5 mm, the first bonding layer 4 is of thickness of about 0.1 mm, the intermediate layer 2 is of thickness lying in the range 0.2 mm to 0.5 mm, the second bonding layer 5 is of thickness of about 0.1 mm, and the outer layer 3 is of thickness lying in the range about 0.2 mm to 0.4 mm.

The hose is made by coextrusion and can be smooth or corrugated.

The hose can be disposed at any point of the vehicle and in particular in the engine compartment of said vehicle or under its bodywork.

Naturally, the invention is not limited to the embodiment described and variants can be applied thereto without going beyond the ambit of the invention as defined by the claims.

In particular, the thicknesses are mentioned only by way of indication and can be modified as a function of the diameter of the hose or to take account of particular conditions of use in connection, for example, with the pressure of the fluid.

1/ A multilayer hose for conveying a motor vehicle fluid, the hose comprising:
an inner layer of polyamide;
an intermediate layer based on a mixture of polyamide and polyolefin; and
an outer layer of a thermoplastic elastomer material based on polyester-ether.

2/ A multilayer hose according to claim 1, wherein the polyolefin of the intermediate layer is polyethylene.

3/ A multilayer hose according to claim 1, wherein the polyamide used in the inner layer is a polyamide 6.

4/ A multilayer hose according to claim 1, including a bonding layer disposed between the inner layer and the intermediate layer, and which possesses adhesive properties relative to the materials of said two layers.

5/ A multilayer hose according to claim 1, including a bonding layer disposed between the intermediate layer and the outer layer, and which possesses adhesive properties relative to the materials of said two layers.

6/ A multilayer hose according to claim 1, wherein the inner layer is of thickness lying in the range 0.2 mm to 0.5 mm.

7/ A multilayer hose according to claim 1, wherein the intermediate layer is of thickness lying in the range 0.2 mm to 0.5 mm.

8/ A multilayer hose according to claim 1, wherein the outer layer is of thickness lying in the range 0.2 mm to 0.4 mm.

9/ A multilayer hose according to claim 4, wherein the bonding layer is of thickness of about 0.1 mm.
